(19) United States
(12) Patent Application Publication
(10) Pub. No.: US 2026/0084813 A1
(43) Pub. Date: Mar. 26, 2026

(54) Method for precision localization of aircraft in dynamic Euclidean reference frames while moving

(71) Applicant: Target Arm Inc., Ridgefield, CT (US)

(72) Inventors: Jeffrey Alan McChesney, Ridgefield, CT (US); Ryan Bennett Bigham, Sandy Hook, CT (US); Ankit Kumar, Woodbury, CT (US)

(73) Assignee: Target Arm Inc., Ridgefield, CT (US)

(21) Appl. No.: 18/897,012

(22) Filed: Sep. 26, 2024

(51) Int. Cl. B64D 5/00; B64U 70/20

(52) U.S. Cl. CPC B64D 5/00; B64U 70/20

(57) ABSTRACT

The present invention relates to capturing and launching autonomous aircraft from moving vehicles. It provides a solution to an aerodynamic problem by enabling precision localization while a host vehicle is moving. This invention is distinguished by using precise local reference frames instead of global reference frames, which enables operations at all speeds. The invention may be used for package delivery, logistics, first responders and the military. The method includes an autonomous aircraft, a host vehicle and an articulated capture device with each of them moving. The invention significantly improves upon existing methods by enabling autonomous aircraft operations with vehicles across a wide range of speeds from zero to highway speeds and beyond.

### CROSS-REFERENCE TO RELATED APPLICATION

NA

### STATEMENT REGARDING FEDERALLY SPONSORED RESEARCH OR DEVELOPMENT

NA

### REFERENCE TO A “SEQUENCE LISTING” (IF APPLICABLE)

NA

### BACKGROUND OF THE INVENTION

An aircraft, can be utilized in a range of applications, including combat, photography, sensing and logistics, mapping, payload delivery, firefighting and more. As a result, many operational needs are challenging, hazardous, or otherwise impractical for manned aircraft or ground-based systems. Fortunately, some key capabilities of aircraft include extended reach, enhanced safety, reduced costs, real-time data collection, speed, range and versatility.

With the advent and maturity of precision localization and autonomous flight controllers, the potential to use autonomous aircraft, also called drones, in various new use cases is profound. In addition, the maturity of autonomous aircraft, both rotary wing and fixed wing, provides wide use worldwide. Even so, as our modern society becomes more mobile every day, our use of autonomous aircraft with moving host vehicles is non-existent. Consequently, many new business models that utilize drones from moving vehicles have not been implemented successfully to date. Examples include package delivery trucks with drones, oil & gas well head inspections, delivering goods and services directly from ships offshore to moving trucks and bypassing docks, or in reverse, and many more.

The one big challenge and problem using autonomous aircraft, though, is their inability to be autonomously launched and recovered from a moving platform easily and reliably. Even if autonomous launch capabilities are achievable, autonomous recovery remains problematic due to the difficulty in accurately localizing between different frames of reference that are themselves moving in six degrees of freedom. Currently, successful autonomous recovery of an aircraft typically requires the host vehicle to come to a complete, or near complete, stop, which severely limits operational flexibility and efficiency. In a military environment, it may also be lethal. Overcoming this stopping problem is essential for improving the versatility and practicality of autonomous aircraft operations in dynamic environments.

Moreover, regardless of whether the aircraft is fully autonomous or remotely controlled, human intervention is typically required for both launching and recovering the aircraft. As the number of aircraft increases, the amount of human interaction required grows proportionally, demanding more personnel and oversight. This reliance on human oversight restricts the potential for fully automated operations, especially when the aircraft needs to be deployed or recovered while the vehicle or platform is in motion. Overcoming the challenge of very precise localization between moving frames of reference enables seamless and efficient aircraft deployment and recovery, reducing the need for human involvement and enhancing the overall efficiency of autonomous aircraft and drone operations.

Existing methods for the autonomous launch and recovery of aircraft generally rely on fixed platforms or specialized equipment, such as catapults for launch and nets, cables or robotic mechanisms for recovery. These systems are effective in static or semi-static environments, where both the aircraft and the platform are stationary or moving at relatively low speeds. In some cases, recovery systems are integrated into vehicles, but they still require the vehicle to stop to safely retrieve the aircraft. These solutions typically use vertical landing as their primary method for a static location due to their inaccuracies with traditional localization methods.

However, these methods present several disadvantages. They often rely on large, cumbersome, or costly equipment, making them impractical for mobile applications or smaller vehicles. Moreover, the need for the vehicle to come to a stop or slow down for recovery severely limits operational flexibility, particularly in dynamic or fast-paced environments such as military operations, search and rescue missions, or industrial inspections. Windy conditions also hamper vertical landing solutions and methods and induce operational limitations. This approach also does not scale well for large aircraft fleets, where manual oversight for launching and recovering multiple aircraft can lead to delays and inefficiencies.

In addition, existing solutions, such as net-type or wire systems, often require human intervention to disengage the aircraft after recovery. Even in cases where these systems are designed for full autonomy, they still face challenges in precisely localizing the aircraft between different frames of reference, especially at higher speeds. This lack of precision increases the risk of failure or accidents, reduces efficiencies and slows operations as the recovery process lacks the accuracy required for a seamless and reliable operation. In short, these vertical landing/capture methods fail to offer a graceful or efficient recovery, which increases the likelihood of damage to the aircraft and compromises the overall effectiveness of the system.

To overcome this limitation, there is a need for a system and method that enables the precise autonomous capture and launch of aircraft from a moving vehicle, eliminating the requirement for the vehicle to come to a stop, or near stop. To do this reliably, the autonomous aircraft needs to continue flying at the same speed of the host vehicle. This system must be capable of extremely high localization precision and accuracy, and must handle different frames of reference dynamically, even at high speeds. Such a solution significantly reduces the need for human intervention, while enhancing the operational efficiency and responsiveness of aircraft deployment, particularly in dynamic environments where continuous motion is essential. This would be especially beneficial in applications such as military operations, search and rescue missions, and large-scale aircraft logistics management and package delivery.

To achieve extreme localization and precision for capture of autonomous aircraft and drones, traditional systems and methods are inadequate. Most rely upon the macro-cartography and geodetic surveys of the global reference frame called Earth. This global reference frame provides latitude and longitude and altitude for many, many uses, but is not accurate enough for autonomous aircraft capture and launch from moving vehicles. The advent of global navigation systems, like the Global Positioning System—GPS, typically provides 5-10 meters accuracy. This is sufficient for navigating around the earth but is insufficient to bring two co-speed objects close together within a centimeter between them. And this lack of precision problem is compounded with three or more objects. What is needed is a system and method to compute precise localization positions between objects, while moving, on-the-edge. This also demands a local reference frame to achieve the accuracy necessary to bring two or more moving objects closely together.

Lastly, to achieve that level of accuracy, the sensors must be highly accurate themselves and provide very high cycle rates for position updates. These high data rates then require sufficient localized compute, along with a sensor fusion engine to apply position algorithms swiftly. The output then needs high-speed computer hardware and software and communications to direct repositioning of the aircraft, the capture device and the host vehicle to achieve capture and launches on-the-move.

### BRIEF SUMMARY OF THE INVENTION

The present invention overcomes the limitations of conventional aircraft systems using global reference frames for navigation, by introducing an advanced system and method for precision localization and stabilization of an articulating mechanism within a localized Euclidean reference frame. This system incorporates specialized algorithms and highly accurate sensors to ensure accurate positioning, even when all local reference points are in motion with relation to each other. The algorithms enable the seamless integration of a moving capture device on a moving vehicle with an autonomous aircraft in flight, allowing for efficient and stable capture and launch while the host vehicle is moving, even at high speeds.

For the purposes of this invention, “aircraft” encompasses various unmanned aerial vehicles, including fixed-wing aircraft, rotary wing aircraft, drones, and any other aerial vehicles that can be remotely or autonomously controlled. The system involves at least three moving bodies within a local frame of reference and the method is using advanced algorithms in a software sensor fusion engine to enable their motion paths to converge with extreme precision for capture or launch while moving. These bodies include a host vehicle, such as a boat, plane, or car; an articulating mechanism, like a robotic mechanism mounted on the host platform, capable of tracking and interacting with the aircraft; a capture device on the articulating mechanism, and an autonomous aircraft.

BRIEF DESCRIPTION OF THE DRAWINGS

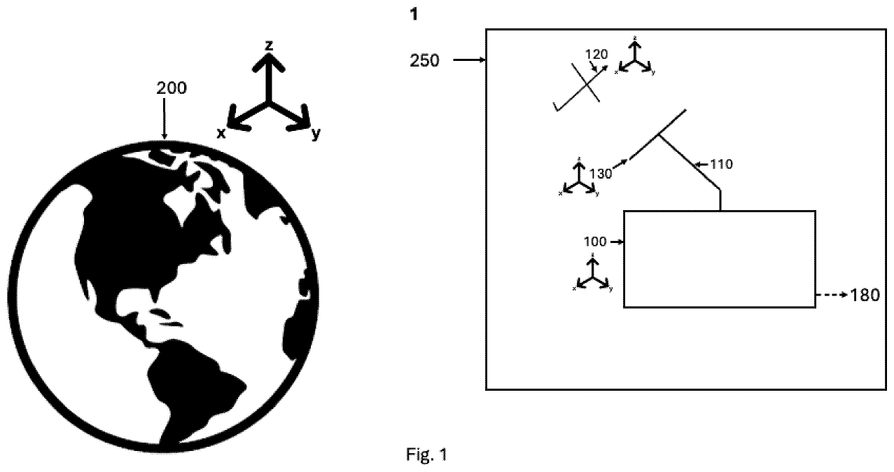

FIG. 1 is a schematic illustration of a global reference frame 200 and a local reference frame system 250 comprising a host vehicle 100 moving in direction 180; with an articulating mechanism 110 attached to host vehicle 100 and also attached to a capture device 130; and an aircraft 120.

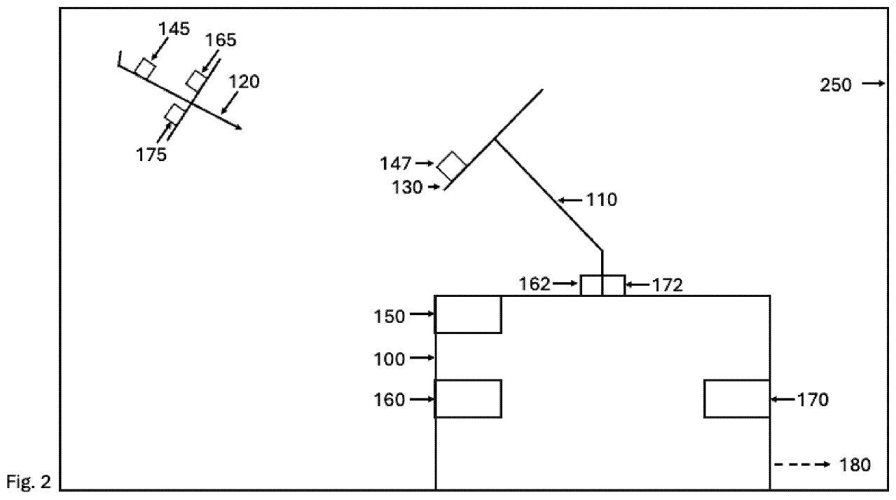

FIG. 2 is a schematic illustration of local reference frame system 250 comprising aircraft 120 approaching host vehicle 100 moving in direction 180; with an articulating mechanism 110 attached with capture device 130; all moving relative to each other.

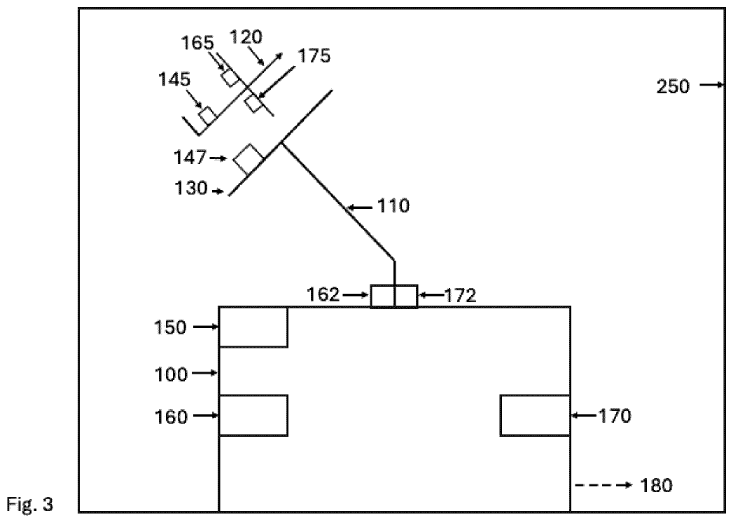

FIG. 3 is a schematic illustration of local reference frame system 250 comprising aircraft 120 being captured by capture device 130 while the host vehicle 100 is moving in direction 180.

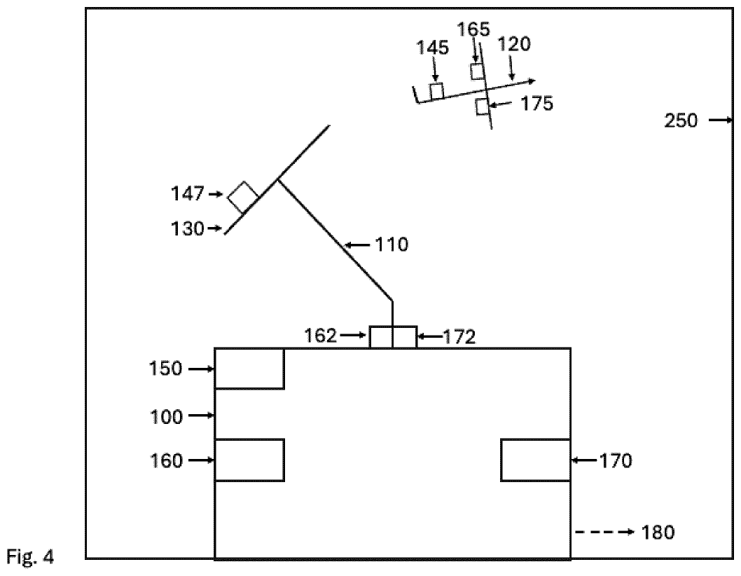

FIG. 4 is a schematic illustration of local reference frame system 250 comprising aircraft 120 being launched by capture device 130 while the host vehicle 100 is moving in direction 180.

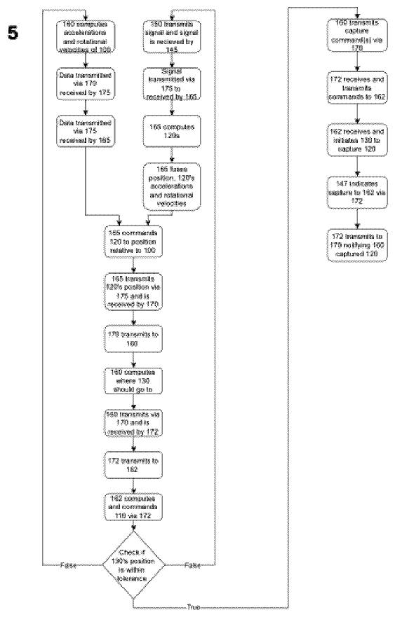

FIG. 5 is a schematic illustration of the method and algorithm to determine relative positions of three objects while moving.

### DETAILED DESCRIPTION OF THE INVENTION

FIG. 1 is an illustration of an embodiment of a system and method to launch and capture an aircraft 120 that is moving, with a moving and articulating mechanism 110, that has a capture device 130 that is attached to secure the aircraft 120. Articulating mechanism 110 is attached to a host vehicle 100 that is moving in the direction of 180. All three main moving devices, aircraft 120, capture device 130 and host vehicle 100 have a global reference frame in Euclidean space with relation to singular body 200 outside of the local reference frames within system 250. Within local reference frame system 250, there are three devices or objects that are moving, and each has its own local Euclidean reference frame with x, y and z axes. The position of any of the three moving devices or objects 100, 130 and 120 can be derived from either the global reference frame 200 for six degrees of freedom, or from comparing each devices'or objects'local reference frames. The vehicle 100, articulating mechanism 110, the capture device 130 and the aircraft 120 can move in all six degrees of freedom.

FIG. 2. is an illustration of local reference frame system 250, which is the same embodiment system and method from FIG. 1, with a host vehicle 100, that can be any moving platform, for example a car, ship, aircraft or train. The dotted arrow line 180 shows the direction of motion of the host vehicle 100 within the local reference frame system and can be defined on any vector within the x, y and z axes. The host vehicle 100 comprises at least one sensor transmitter 150, at least one computer hardware component 160, and at least one communication hardware component 170. Any of the electronic components 150, 160 or 170, can be combined into a merged unit, or located anywhere on the articulating mechanism or capture device 130. The host vehicle 100 has a sensor transmitter 150 for providing relative local position distances and angles to aircraft 120's sensor receiver 145. Aircraft 120 can be an autonomous rotary wing aircraft comprising of at least one blade, or an autonomous fixed wing aircraft. Computer hardware component 160 performs digital method calculations for accelerations and rotational velocities of host vehicle 100 and transmits these data to communication hardware 170, which then transmits to communication hardware 175, and then to computer hardware component 165, which then computes aircraft 120's relative positions between host vehicle 100. These calculations provide relative x, y and z axes locations as well as rotations around each of these axes for relative 6 degrees of freedom calculations. Computer hardware component 162 may also perform digital method calculations for relative positions between host vehicle 100, capture device 130 and aircraft 120. These calculations provide relative x, y and z axes locations as well as rotations around each of those axes for relative 6 degrees of freedom calculations, and command articulating mechanism 110 to position capture device 130 for aircraft 120 capture. Communication hardware component 170 provides bi-directional and unidirectional data messaging and processing between aircraft 120 with its communications hardware component 175, as well as articulating mechanism communications hardware component 172. Simultaneously, sensor transmitter 150 transmits its signals, which are received by sensor receiver 145, and then transmits this data via communication hardware component 175 to computer hardware component 165. Computer hardware component 165 then performs digital method calculations for relative positions between host vehicle 100, capture device 130 and aircraft 120 and commands aircraft 120 to a point around host vehicle 100 and within the articulating mechanism 110's range of motion.

Aircraft 120 comprises of sensor receiver 145 to provide localization position and rotations relative to the host vehicle 100 and capture device 130. The method and algorithms for calculating these relative positions are computed within the aircraft 120's computer hardware component 165. These algorithms provide a calculation for all three reference frames relative to one another via a sensor fusion engine within the computer hardware component 165. The resultant reference location of aircraft 120 then directs the aircraft's flight controller within the computer hardware component 165 to fly towards a Euclidian point designated in relation to host vehicle 100 which is within the capture device 130's range of motion. Similarly, the aircraft 120's communication hardware component 175 transmits the relative localization position to the host vehicle 100's communication hardware component 170, which then transmits it to computer hardware component 160, which then applies an algorithm to define all three moving objects relative positions, and then sends a command message to communication hardware component 170, which sends the command to the articulating mechanism 110's communication hardware component 172, and then to computer hardware component 162 which commands the articulating mechanism to move the capture device 130 to a dynamic point within its range of motion. Upon receiving these communications, the host vehicle 100's computer hardware component 160 and the articulating mechanism's computer hardware component 162 compute varying algorithms to optimize trajectories and capture of aircraft 120 by adjusting locations or relative motion. The algorithm within computer hardware component 160 combines the accelerations and rotational velocities of host vehicle 100, as well as the relative distances and angles from the sensor receiver 147 to compute the precise relative point to fly to for capture or to launch. This process repeats until aircraft 120 is at the calculated, relative point.

As another embodiment, the sensor transmitter 150 and sensor receiver 145 may be reversed and mounted on the opposing devices.

Another embodiment would be that the method and algorithms for calculating these relative positions of aircraft 120's relative positions can be computed on any other computer hardware component 165 globally or locally. In this case the relative position is communicated back to aircraft 120 via communications device 175 which then sends the relative update position to computer hardware component 165.

Another embodiment would be in a communications-denied environment so that communications hardware components 160, 162 and 165 could not transmit any messages between them. In this embodiment, aircraft 120 performs its own localization and trajectory calculations in computer hardware 165, without support from computer hardware components 160 or 162. Sensor receiver 145 provides localization position and angles from sensor transmitter 150 directly to the computer hardware component 175 for trajectory to approach capture device 130 and be captured.

Various alternative embodiments of sensor receivers and transmitters may provide relative localization and angles, including but not limited to optical-based, infrared, and radio-frequency-based systems, as will be readily understood by those skilled in the art. The communications hardware components 170, 172 and 175 can use various protocols and waveforms including, but not limited to radiofrequency (RF), cellular, Wi-Fi, wired-based or other methods known by a person skilled in the art.

The articulating mechanism 110 offers a significant advantage by enabling rapid, real-time, low latency tracking of the aircraft 120 and positioning of capture device 130. Additionally, it provides the mechanical strength necessary to withstand various forces, such as impact forces, encountered during the capture of the aircraft 120. The aforementioned forces may include, but are not limited to, any forces that are commonly understood by those skilled in the art. The articulating mechanism 110 can be, but is not limited to, a serial robot, parallel robot, gantry robot, or other mechanisms to position the capture device 130 known to those skilled in the art. Articulating Mechanism 110 has at least one capture device 130. The capture device 130 may comprise a locking mechanism for mating aircraft 120 and holding it securely while launching and recovering. The locking mechanism can be pneumatic, mechanical, electromagnetic or other mechanisms known to those skilled in the art.

Another embodiment of the invention may include more than three devices (vehicle 100, articulating mechanism 110 and aircraft 120). This embodiment may include multiple aircraft 120 or vehicles 100 or articulating mechanisms 110.

FIG. 3 is an illustration of the same embodiments of FIG. 1 and FIG. 2 at the point of capture of aircraft 100 by the capture device 130. The sensors, communications and algorithmic methods of computing relative local reference frames are the same as depicted in FIG. 2 illustrations. Upon arriving at the computed relative point, aircraft 120 flies to remain within a set tolerance for range of motion. At the same time, via communications outlined in FIG. 2 above, computer hardware component 160 sends a capture command to communications hardware component 170, and then to communications hardware 172, and then to computer hardware component 162 which directs the capture device 130 to initiate capture. Sensor receiver 147 then sends a successful capture message to computer hardware component 162, then to communications hardware component 172, then to communications hardware component 170, and finally to the computer hardware component 160.

FIG. 4 is an illustration of the same embodiments of FIG. 1 and FIG. 2 at the point of launch of aircraft 100 by the capture device 130. The same communications and sensors as of capture in FIG. 3 above, are also to command capture device 130 to release the aircraft 120. Differing in this case, the sensor receiver 147 has a null response for recognizing aircraft 120 is captured and send that message through the aforementioned communications pathway to computer hardware component 160. Aircraft 120 then flies away from the capture device 130, the articulating mechanism 110 and its host vehicle 100. The sensors, communications and algorithmic methods of computing relative local reference frames are the same as depicted in FIG. 3 illustrations.

FIG. 5 Is an illustration of the method and algorithm to determine relative positions of three objects while moving. This logic tree and flowchart indicates the various components and algorithms used throughout the process.

1. CA method of capturing and launching an autonomous aircraft inflight with a moving capture device mounted on an articulating mechanism, which is mounted to a moving host vehicle, using sensors and local reference frames for precise localization positioning, said method comprising the steps of:
a. Using sensors to determine precise distances and angles between three or more moving objects comprising an aircraft, a capture device, and a host vehicle, wherein the sensors comprise mechanical, infrared, visible light, and other electromagnetic waveforms for distance and angle measurements;
b. Computing local Euclidean reference frame positions of the aircraft, the capture device, and the host vehicle, wherein said method supports more than three moving objects;
c. Determining each object's relative position and motion path with respect to each other object;
d. Commanding an articulating mechanism to a fixed point moving with the host vehicle, comprising a free-moving end with a capture device and a secured end attached to the host vehicle;
e. Controlling the capture device's position relative to the autonomous aircraft based on the sensor inputs and calculated relative positions;
f. Capturing and launching the autonomous aircraft using the capture device.

2. A method of controlling the motion of an autonomous aircraft and a capture device using computational processes and algorithms, said method comprising the steps of:
a. Calculating local Euclidean reference frame positions, velocities, and accelerations of an aircraft, a capture device, and a host vehicle based on sensor inputs, wherein the computations are performed on any available computer hardware component locally or globally;
b. Using differentiation with respect to time to compute relative velocities and accelerations of the moving objects;
c. Directing the motion path of the autonomous aircraft relative to a fixed point moving with the host vehicle, using computer algorithms to command the movement of the capture device;
d. Controlling the capture device's position using algorithms executed on any available computer hardware component locally or globally;
e. Capturing and launching the autonomous aircraft using the computed relative positions, velocities, and accelerations, with the capture device controlled by computer algorithms.

3. A method of capturing and launching an autonomous aircraft inflight in various environments using a moving capture device mounted on an articulating mechanism, said method comprising the steps of:
a. Operating moving objects comprising an aircraft, a capture device, and a host vehicle in environments including air, ground, on water, and underwater, wherein more than three moving objects can be used for localization;
b. Using sensors, including mechanical, infrared, visible light, and other electromagnetic waveforms, to determine distances and angles between the moving objects in these environments;
c. Directing the motion path of the autonomous aircraft relative to a fixed point moving with the host vehicle, wherein the capture device can be mounted at any point on the articulating mechanism or host vehicle;
d. Commanding the articulating mechanism to a fixed point moving with the host vehicle, comprising a free-moving end with a capture device and a secured end to the host vehicle;
e. Capturing and launching the aircraft using the capture device, adapted for operation in the given environment.
